(19) United States
(12) Patent Application Publication
(10) Pub. No.: US 2012/0304665 A1
(43) Pub. Date: Dec. 6, 2012

(54) MOUNT DEVICE FOR TRANSITION DUCT IN TURBINE SYSTEM

(75) Inventors: Jeffrey Scott LeBegue, Simpsonville, SC (US); Kevin Weston McMahan, Greer, SC (US); Ronnie Ray Pentecost, Travelers Rest, SC (US); James Scott Flanagan, Simpsonville, SC (US)

(73) Assignee: GENERAL ELECTRIC COMPANY, Schenectady, NY (US)

(21) Appl. No.: 13/152,613

(22) Filed: Jun. 3, 2011

(51) Int. Cl. F02C 7/20

(52) U.S. Cl. 60/796

(57) ABSTRACT

A mount device and mounting assembly for a turbine system are disclosed. The mounting assembly includes a transition duct extending between a fuel nozzle and a turbine section. The transition duct has an inlet, an outlet, and a passage extending between the inlet and the outlet and defining a longitudinal axis, a radial axis, and a tangential axis. The outlet of the transition duct is offset from the inlet along the longitudinal axis and the tangential axis. The mounting assembly further includes a mount device connecting the transition duct to the turbine section. The mount device is configured to allow movement of the outlet about at least two axes.

### FIELD OF THE INVENTION

The subject matter disclosed herein relates generally to turbine systems, and more particularly to mount devices for transition ducts in turbine systems.

### BACKGROUND OF THE INVENTION

Turbine systems are widely utilized in fields such as power generation. For example, a conventional gas turbine system includes a compressor section, a combustor section, and at least one turbine section. The compressor section is configured to compress air as the air flows through the compressor section. The air is then flowed from the compressor section to the combustor section, where it is mixed with fuel and combusted, generating a hot gas flow. The hot gas flow is provided to the turbine section, which utilizes the hot gas flow by extracting energy from it to power the compressor, an electrical generator, and other various loads.

The compressor sections of turbine systems generally include tubes or ducts for flowing the combusted hot gas therethrough to the turbine section or sections. Recently, compressor sections have been introduced which include tubes or ducts that shift the flow of the hot gas. For example, ducts for compressor sections have been introduced that, while flowing the hot gas longitudinally therethrough, additionally shift the flow radially or tangentially such that the flow has various angular components. These designs have various advantages, including eliminating first stage nozzles from the turbine sections. The first stage nozzles were previously provided to shift the hot gas flow, and may not be required due to the design of these ducts. The elimination of first stage nozzles may eliminate associated pressure drops and increase the efficiency and power output of the turbine system.

However, the connection of these ducts to turbine sections is of increased concern. For example, because the ducts do not simply extend along a longitudinal axis, but are rather shifted off-axis from the inlet of the duct to the outlet of the duct, thermal expansion of the ducts can cause undesirable shifts in the ducts along or about various axes. These shifts can cause stresses and strains within the ducts, and may cause the ducts to fail.

Thus, an improved mount device and mounting assembly for connecting a compressor duct to a turbine section of a turbine system would be desired in the art. For example, a mount device and mounting assembly that allow for thermal growth of the duct would be advantageous.

BRIEF DESCRIPTION OF THE INVENTION

Aspects and advantages of the invention will be set forth in part in the following description, or may be obvious from the description, or may be learned through practice of the invention.

In one embodiment, a mounting assembly for a turbine system is disclosed. The mounting assembly includes a transition duct extending between a fuel nozzle and a turbine section. The transition duct has an inlet, an outlet, and a passage extending between the inlet and the outlet and defining a longitudinal axis, a radial axis, and a tangential axis. The outlet of the transition duct is offset from the inlet along the longitudinal axis and the tangential axis. The mounting assembly further includes a mount device connecting the transition duct to the turbine section. The mount device is configured to allow movement of the outlet about at least two axes.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a cross-sectional view of several portions of a gas turbine system according to one embodiment of the present disclosure;

FIG. 2 is a perspective view of an annular array of transition ducts according to one embodiment of the present disclosure;

FIG. 3 is a rear perspective view of a transition duct according to one embodiment of the present disclosure;

FIG. 4 is a top view of a transition duct according to one embodiment of the present disclosure;

FIG. 5 is a top perspective view of a transition duct according to one embodiment of the present disclosure;

FIG. 6 is a top perspective view of a transition duct according to another embodiment of the present disclosure; and

FIG. 7 is a top perspective view of a transition duct according to another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

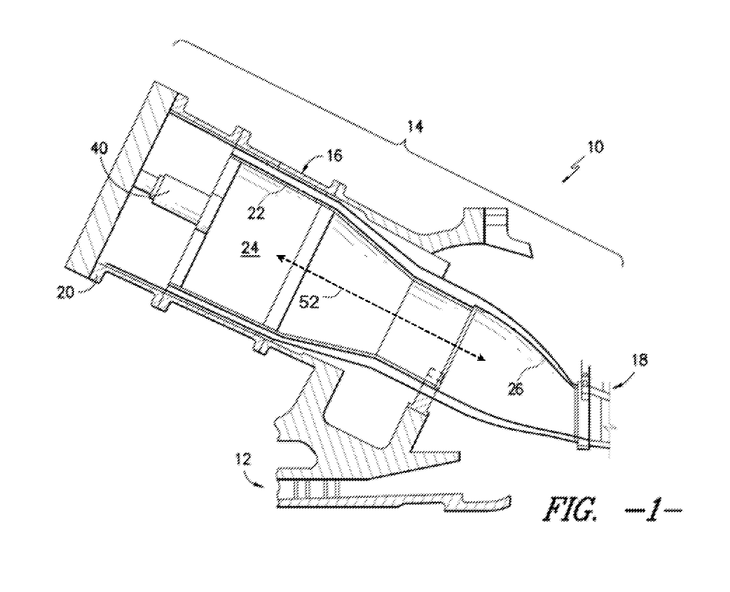

Referring to FIG. 1, a simplified drawing of several portions of a gas turbine system 10 is illustrated. It should be understood that the turbine system 10 of the present disclosure need not be a gas turbine system 10, but rather may be any suitable turbine system 10, such as a steam turbine system or other suitable system.

The gas turbine system 10 as shown in FIG. 1 comprises a compressor section 12 for pressurizing a working fluid, discussed below, that is flowing through the system 10. Pressurized working fluid discharged from the compressor section 12 flows into a combustor section 14, which is generally characterized by a plurality of combustors 16 (only one of which is illustrated in FIG. 1) disposed in an annular array about an axis of the system 10. The working fluid entering the combustor section 14 is mixed with fuel, such as natural gas or another suitable liquid or gas, and combusted. Hot gases of combustion flow from each combustor 16 to a turbine section 18 to drive the system 10 and generate power.

A combustor 16 in the gas turbine 10 may include a variety of components for mixing and combusting the working fluid and fuel. For example, the combustor 16 may include a casing 20, such as a compressor discharge casing 20. A variety of sleeves, which may be axially extending annular sleeves, may be at least partially disposed in the casing 20. The sleeves, as shown in FIG. 1, extend axially along a generally longitudinal axis 90, such that the inlet of a sleeve is axially aligned with the outlet. For example, a combustor liner 22 may generally define a combustion zone 24 therein. Combustion of the working fluid, fuel, and optional oxidizer may generally occur in the combustion zone 24. The resulting hot gases of combustion may flow generally axially along the longitudinal axis 52 downstream through the combustion liner 22 into a transition piece 26, and then flow generally axially along the longitudinal axis 90 through the transition piece 26 and into the turbine section 18.

The combustor 16 may further include a fuel nozzle 40 or a plurality of fuel nozzles 40. Fuel may be supplied to the fuel nozzles 40 by one or more manifolds (not shown). As discussed below, the fuel nozzle 40 or fuel nozzles 40 may supply the fuel and, optionally, working fluid to the combustion zone 24 for combustion.

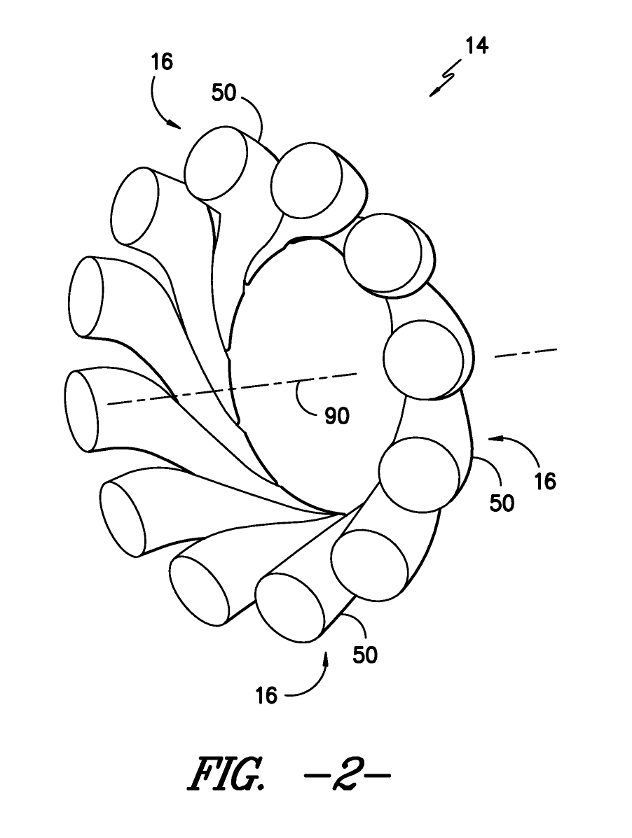

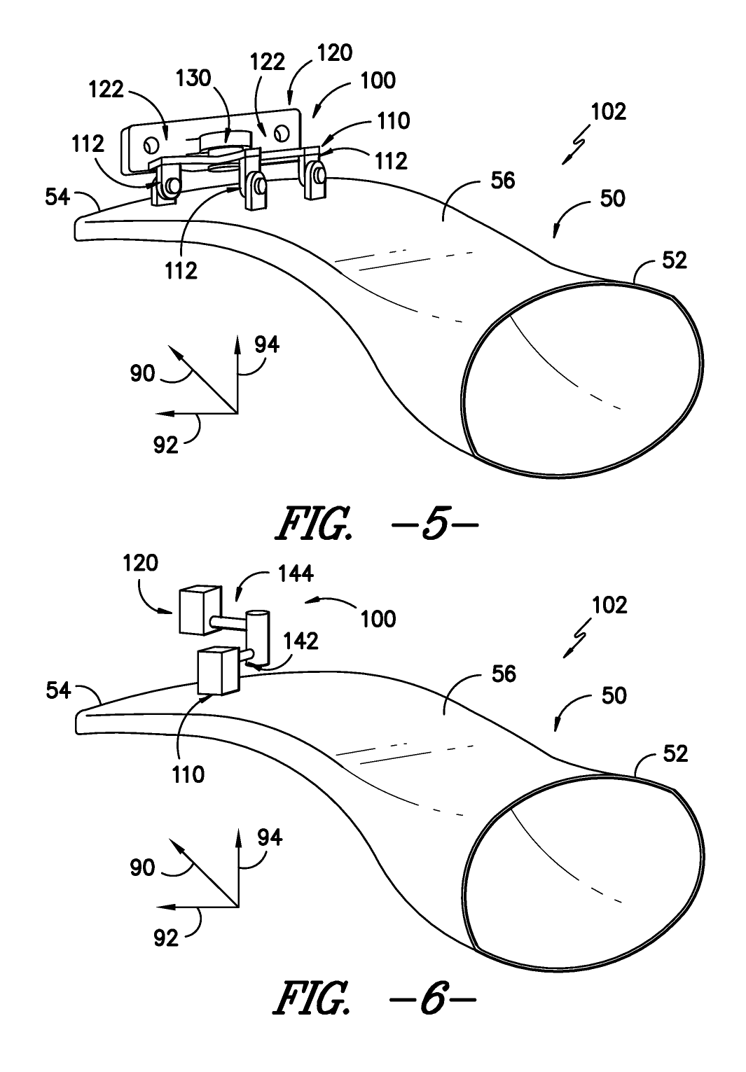

As shown in FIGS. 2 through 7, a combustor 16 according to the present disclosure may include a transition duct 50 extending between the fuel nozzle 40 or fuel nozzles 40 and the turbine section 18. The transition ducts 50 of the present disclosure may be provided in place of various axially extending sleeves of other combustors. For example, a transition duct 50 may replace the axially extending combustor liner 22 and transition piece 26 of a combustor, and, as discussed below, may provide various advantages over the axially extending combustor liners 22 and transition pieces 26 for flowing working fluid therethrough and to the turbine section 18.

As shown, the plurality of transition ducts 50 may be disposed in an annular array about longitudinal axis 90. Further, each transition duct 50 may extend between a fuel nozzle 40 or plurality of fuel nozzles 40 and the turbine section 18. For example, each transition duct 50 may extend from the fuel nozzles 40 to the transition section 18. Thus, working fluid may flow generally from the fuel nozzles 40 through the transition duct 50 to the turbine section 18. In some embodiments, the transition ducts 50 may advantageously allow for the elimination of the first stage nozzles in the turbine section, which may eliminate any associated drag and pressure drop and increase the efficiency and output of the system 10.

Each transition duct 50 may have an inlet 52, an outlet 54, and a passage 56 therebetween. The inlet 52 and outlet 54 of a transition duct 50 may have generally circular or oval cross-sections, rectangular cross-sections, triangular cross-sections, or any other suitable polygonal cross-sections. Further, it should be understood that the inlet 52 and outlet 54 of a transition duct 50 need not have similarly shaped cross-sections. For example, in one embodiment, the inlet 52 may have a generally circular cross-section, while the outlet 54 may have a generally rectangular cross-section.

Further, the passage 56 may be generally tapered between the inlet 52 and the outlet 54. For example, in an exemplary embodiment, at least a portion of the passage 56 may be generally conically shaped. Additionally or alternatively, however, the passage 56 or any portion thereof may have a generally rectangular cross-section, triangular cross-section, or any other suitable polygonal cross-section. It should be understood that the cross-sectional shape of the passage 56 may change throughout the passage 56 or any portion thereof as the passage 56 tapers from the relatively larger inlet 52 to the relatively smaller outlet 54.

The outlet 54 of each of the plurality of transition ducts 50 may be offset from the inlet 52 of the respective transition duct 50. The term “offset”, as used herein, means spaced from along the identified coordinate direction. The outlet 54 of each of the plurality of transition ducts 50 may be longitudinally offset from the inlet 52 of the respective transition duct 50, such as offset along the longitudinal axis 90.

Additionally, in exemplary embodiments, the outlet 54 of each of the plurality of transition ducts 50 may be tangentially offset from the inlet 52 of the respective transition duct 50, such as offset along a tangential axis 92. Because the outlet 54 of each of the plurality of transition ducts 50 is tangentially offset from the inlet 52 of the respective transition duct 50, the transition ducts 50 may advantageously utilize the tangential component of the flow of working fluid through the transition ducts 30 to eliminate the need for first stage nozzles (not shown) in the turbine section 18.

Further, in exemplary embodiments, the outlet 54 of each of the plurality of transition ducts 50 may be radially offset from the inlet 52 of the respective transition duct 50, such as offset along a radial axis 94. Because the outlet 54 of each of the plurality of transition ducts 50 is radially offset from the inlet 52 of the respective transition duct 50, the transition ducts 50 may advantageously utilize the radial component of the flow of working fluid through the transition ducts 30 to further eliminate the need for first stage nozzles (not shown) in the turbine section 18.

It should be understood that the tangential axis 92 and the radial axis 94 are defined individually for each transition duct 50 with respect to the circumference defined by the annular array of transition ducts 50, as shown in FIG. 2., and that the axes 92 and 94 vary for each transition duct 50 about the circumference based on the number of transition ducts 50 disposed in an annular array about the longitudinal axis 90.

Each transition duct 50 of the present disclosure must be mounted to turbine section 18. Thus, the present disclosure is further directed to a mount device 100 for connecting a transition duct 50 to a turbine section 18, and to a mounting assembly 102 for a turbine system 10. The mounting assembly 102 may comprise the transition duct 50 or transition ducts 50 extending between the fuel nozzle 40 and turbine section 18, and the mount device 100 or mount devices 100 connecting the transition duct 50 or transition ducts 50 to the turbine section 18. Each mount device 100 may connect one of the transition ducts 50 to the turbine section 18. The mount device 100 and mounting assembly 102 of the present disclosure may allow the transition duct 50, such as the outlet 54 of the transition duct 50, to move about at least two axes. This may advantageously accommodate the thermal growth of the transition duct 50, which may be offset as discussed above, while allowing the transition duct 50 to remain sufficiently sealed to the turbine section 18. For example, thermal growth of the offset transition duct 50 may cause the inlet 52 and outlet 54 of the transition duct 50 to shift with respect to each other about various axes. The mount device 100 and mounting assembly 102 may accommodate these shifts, and may reduce the development of stresses and strains in the transition duct 50 due to thermal growth.

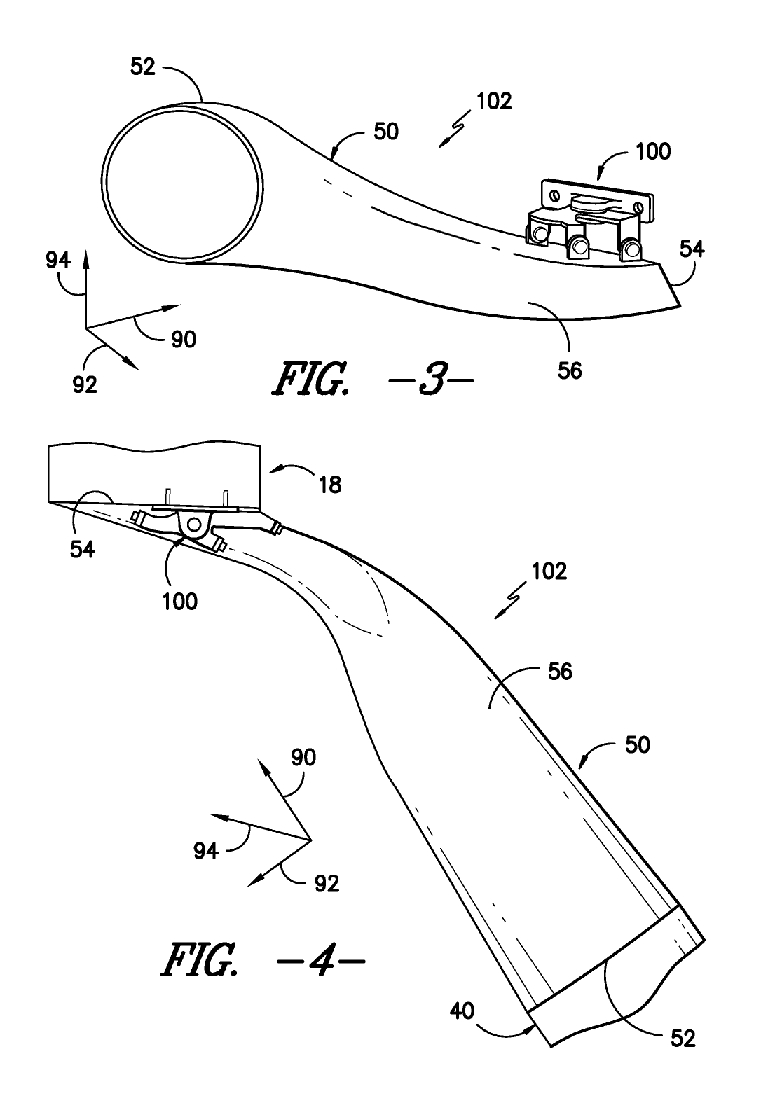

As shown in FIGS. 3 through 7, the mount device 100 may include a first support bracket 110 or plurality of first support brackets 110. The first support brackets 110 may be configured for connecting the mount device 100 to the transition duct 50. Thus, a first support bracket 110 may comprise a connection point 112 or a plurality of connection points 112 for connection to the transition duct 50. The connection points 112 may be those portions of the support bracket 110 that provide the connection to the transition duct 50. For example, in some embodiments, a connection point 112 may be a portion of the support bracket 110, such as a leg, a plate, or a portion thereof, that is provided for mechanical fastening to the transition duct 50, such as with screws, nails, rivets, nut/bolt combinations, or other suitable mechanical fasteners. In other embodiments, a connection point 112 may be a portion of the support bracket 110, such as a leg, a plate, or a portion thereof, that is provided for welding, soldering, fastening with adhesive, or other suitable fastening to the transition duct 50. In some exemplary embodiments, as shown in FIGS. 3 through 5, a support bracket 110 may comprise at least three connection points 112. This may allow for the support bracket 110 to be appropriately balanced on and connected to the transition duct 50. It should be understood, however, that the present disclosure is not limited to a support bracket 110 having at least three connection points 112, but rather that any suitable number of connection points is within the scope and spirit of the present disclosure.

As shown in FIGS. 3 through 7, the mount device 100 may further include a second support bracket 120 or plurality of second support brackets 120. The second support brackets 120 may be configured for connecting the mount device 100 to the turbine section 18. Thus, a second support bracket 120 may comprise a connection point 122 or a plurality of connection points 122 for connection to the turbine section 18. The connection points 122 may be those portions of the support bracket 120 that provide the connection to the turbine section 18. For example, in some embodiments, a connection point 122 may be a portion of the support bracket 120, such as a leg, a plate, or a portion thereof, that is provided for mechanical fastening to the turbine section 18, such as with screws, nails, rivets, nut/bolt combinations, or other suitable mechanical fasteners. In other embodiments, a connection point 122 may be a portion of the support bracket 120, such as a leg, a plate, or a portion thereof, that is provided for welding, soldering, fastening with adhesive, or other suitable fastening to the turbine section 18. In exemplary embodiments, a support bracket 120 may comprise at least three connection points 122. This may allow for the support bracket 120 to be appropriately balanced on and connected to the turbine section 18. It should be understood, however, that the present disclosure is not limited to a support bracket 120 having at least three connection points 122, but rather that any suitable number of connection points is within the scope and spirit of the present disclosure.

As discussed above and shown in FIGS. 3 through 7, the mount device 100 connecting the transition duct 50 to the turbine section 18 may be configured to allow movement of the transition duct 50, such as of the outlet 54 of the transition duct 50, about at least two axes. Further, in some exemplary embodiments, the mount device 100 may be configured to allow movement of the transition duct 50, such as of the outlet 54 of the transition duct 50, about three axes. Thus, the mount device 100 may be configured to allow movement of the transition duct 50, such as of the outlet 54 of the transition duct 50, about at least two of the longitudinal axis 90, the tangential axis 92, and the radial axis 94. In exemplary embodiments, for example, the mount device 100 may allow movement of the transition duct 50, such as of the outlet 54 of the transition duct 50, about the tangential axis 92 and the radial axis 94. Further, the mount device 100 in some embodiments may additionally allow movement of the transition duct 50, such as of the outlet 54 of the transition duct 50, about the longitudinal axis 90. It should be understood that a mount device 100 that allows movement of the transition duct 50, such as of the outlet 54 of the transition duct 50, about any combination of two or three axes is within the scope and spirit of the present disclosure.

Thus, the mount device 100 may comprise any device or combination of devices that allow for rotation about at least two axes. For example, in some embodiments, as shown in FIGS. 3 through 5 and 7, the mount device 100 may be a multi-axis joint. For example, FIGS. 3 through 5 and 7 illustrate various embodiment of a multi-axis joint according to the present disclosure, in which the multi-axis joint is a ball joint 130. The ball joint 130 may comprise a generally spherical ball 132 enclosed in a socket 134. The ball 132 may be connected to one of the transition duct 50 or turbine section 18, such as through one of a first support bracket 110 or second support bracket 120, while the socket is connected to the other of the transition duct 50 or turbine section 18, such as through another of a first support bracket 110 or second support bracket 120. Movement of the ball 132 in the socket 134 may allow for rotational movement of the transition duct 50, such as of the outlet 54 of the transition duct 50, with respect to the turbine section 18 about at least two, and in exemplary embodiments three, axes.

The ball joint 130 according to the present disclosure may, in some embodiments, be a sealed ball joint. Alternatively, the ball joint 130 may be unsealed. Further, the ball joint 130 may in some embodiments include spring or other biasing apparatus, which may for example bias the ball 132 with respect to the socket 134.

It should be understood that the present disclosure is not limited to ball joints 130, and rather that any suitable multi-axis joint that provides at least two degrees of rotational freedom is within the scope and spirit of the present disclosure.

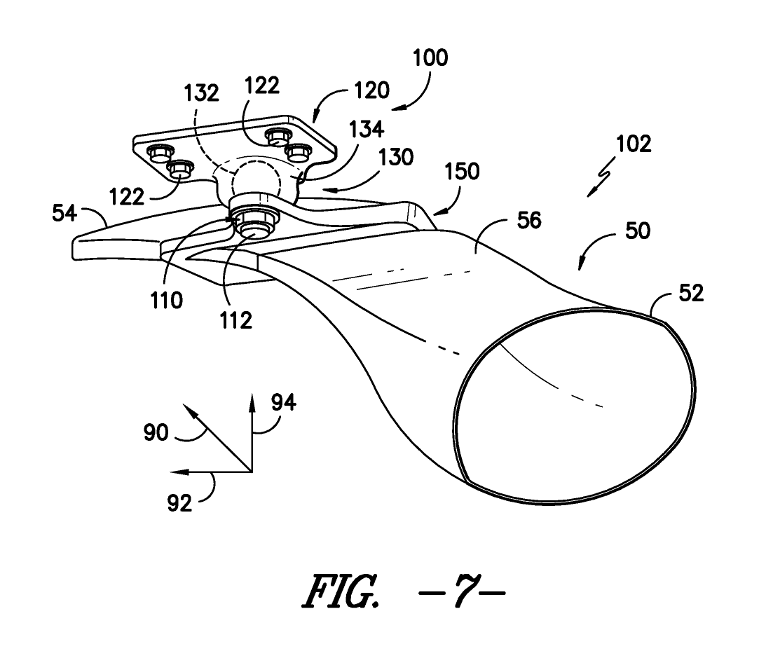

In alternative embodiments, as shown in FIG. 6, the mount device 100 may comprise a plurality of joints, each joint separately rotatable about an axis or a plurality of axes. For example, FIG. 6 illustrate a mount device 100 comprising a first joint 142 and a second joint 144. It should be understood that more than two joints may be utilized as desired or required. The first joint 142 may be rotatable at least about a first axis, while the second joint 144 is rotatable about at least a second axis. For example, the first joint 142 and the second joint 144 may each be a revolute joint, thus having one rotational axis of freedom. The first axis may be any one of the longitudinal axis 90, the tangential axis 92, and the radial axis 94, while the second axis may be any other of the longitudinal axis 90, the tangential axis 92, and the radial axis 94. Thus, each of the first joint 142 and the second joint 144 may allow for rotational movement of the transition duct 50, such as of the outlet 54 of the transition duct 50, with respect to the turbine section 18 about at least one axis.

It should be understood that the present disclosure is not limited to revolute joints, and rather that any suitable joints that provide at least one degree of rotational freedom are within the scope and spirit of the present disclosure.

In some embodiment, as shown in FIG. 7, a transition duct 50 according to the present disclosure may comprise an aft frame 150. The aft frame 150 may generally be a flange-like frame surrounding the exterior of the transition duct 50. The aft frame 150 may be located generally adjacent to the outlet 54. Further, the aft frame 150, while adjacent to the outlet 54, may be spaced from the outlet 54, or may be provided at the outlet to connect the transition duct 50 to the turbine section 18. In some embodiments, the aft frame 150 may include various channels or apertures therein to facilitate cooling of the transition duct 50.

In exemplary embodiments, as shown in FIGS. 7, the mount device 100 may be connected, as discussed above, to the aft frame 150. Alternatively, the mount device 100 may simply be connected to the transition duct 50.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A mounting assembly for a turbine system, the mounting assembly comprising:
a transition duct extending between a fuel nozzle and a turbine section, the transition duct having an inlet, an outlet, and a passage extending between the inlet and the outlet and defining a longitudinal axis, a radial axis, and a tangential axis, the outlet of the transition duct offset from the inlet along the longitudinal axis and the tangential axis; and
a mount device connecting the transition duct to the turbine section, the mount device configured to allow movement of the outlet about at least two axes.

2. The mounting assembly of claim 1, wherein the outlet of the transition duct is further offset from the inlet along the radial axis.

3. The mounting assembly of claim 1, wherein the mount device is configured to allow movement of the outlet about three axes.

4. The mounting assembly of claim 1, wherein the mount device is configured to allow movement of the outlet about the tangential axis and the radial axis.

5. The mounting assembly of claim 4, wherein the mount device is further configured to allow movement of the outlet about the longitudinal axis.

6. The mounting assembly of claim 1, wherein the mount device comprises a multi-axis joint.

7. The mounting assembly of claim 6, wherein the multi-axis joint is a ball joint.

8. The mounting assembly of claim 1, wherein the mount device comprises a first joint rotatable about a first axis and a second joint rotatable about a second axis.

9. The mounting assembly of claim 1, wherein the transition duct further comprises an aft frame adjacent the outlet, and wherein the mount device is connected to the aft frame.

10. The mounting assembly of claim 1, wherein the mount device further comprises a support bracket, the support bracket comprising at least three connection points for connection to the transition duct.

11. The mounting assembly of claim 1, further comprising a plurality of transition ducts and a plurality of mount devices, each of the plurality of transition ducts disposed annularly about the longitudinal axis, each of the plurality of mount devices connecting one of the plurality of transition ducts to the turbine section.

12. A turbine system, comprising:
a fuel nozzle;
a turbine section;
a transition duct extending between the fuel nozzle and the turbine section, the transition duct having an inlet, an outlet, and a passage extending between the inlet and the outlet and defining a longitudinal axis, a radial axis, and a tangential axis, the outlet of the transition duct offset from the inlet along the longitudinal axis and the tangential axis; and
a mount device connecting the transition duct to the turbine section, the mount device configured to allow movement of the outlet about at least two axes.

13. The turbine system of claim 12, wherein the outlet of the transition duct is further offset from the inlet along the radial axis.

14. The turbine system of claim 12, wherein the mount device is configured to allow movement of the outlet about three axes.

15. The turbine system of claim 12, wherein the mount device is configured to allow movement of the outlet about the tangential axis and the radial axis.

16. The turbine system of claim 12, wherein the mount device comprises a multi-axis joint.

17. The turbine system of claim 12, wherein the mount device comprises a first joint rotatable about a first axis and a second joint rotatable about a second axis.

18. The turbine system of claim 12, wherein the transition duct further comprises an aft frame adjacent the outlet, and wherein the mount device is connected to the aft frame.

19. The turbine system of claim 12, wherein the mount device further comprises a support bracket, the support bracket comprising at least three connection points for connection to the transition duct.

20. The turbine system of claim 12, further comprising a plurality of fuel nozzles, a plurality of transition ducts, and a plurality of mount devices, each of the plurality of transition ducts disposed annularly about the longitudinal axis and extending between one of the plurality of fuel nozzles and the turbine section, each of the plurality of mount devices connecting one of the plurality of transition ducts to the turbine section.
